(19) United States
(12) Patent Application Publication
(10) Pub. No.: US 2013/0012395 A1
(43) Pub. Date: Jan. 10, 2013

(54) SUPERCONDUCTING WIRE AND THE PROCESS OF MANUFACTURE

(75) Inventors: Kazuhide Tanaka, Hitachi (JP); Motomune Kodama, Hitachi (JP); Yasuo Kondo, Hitachinaka (JP)

(73) Assignee: HITACHI, LTD., Tokyo (JP)

(21) Appl. No.: 13/542,136

(22) Filed: Jul. 5, 2012

(30) Foreign Application Priority Data
Jul. 5, 2011 (JP) 2011-149300

(51) Int. Cl. H01B 12/04; B01F 3/18; H01B 13/00

(52) U.S. Cl. 505/230; 505/430; 366/348; 174/125.1

(57) ABSTRACT

A superconducting wire which is obtained by a heat treatment at a lower temperature than related art and has a high critical current density, and the process of manufacture can be provided by causing a compound expressed by the following formula (1) to be contained:

Mg(B₁₋ₓCₓ)_{y} (1)
where x is a number satisfying 0<x<1, and y is a number satisfying 2.1≦y.

### BACKGROUND OF THE INVENTION

1. Field of the Invention

The present invention relates to a superconducting wire and the process of manufacture.

2. Description of the Related Art

Recently, it is known that magnesium diboride (MgB₂) exhibits superconducting properties at 39 K (see non-patent document 1). In addition, for example, the following properties are known as the specific content of properties of magnesium diboride.

(1) The critical temperature is 39 K as stated above. This temperature is higher than the critical temperature of a related art metal superconductor by 20 K or more.

(2) Weak coupling and large magnetization relaxation, which significantly appear in a copper oxide superconductor, are small.

(3) Since there are abundant magnesium diboride resources, it can be obtained relatively at low cost.

(4) The mechanical strength is high.

(5) The magnetic anisotropy is small, and an equal current can be made to flow in any directions of a-axis, b-axis and c-axis of the crystal.

(6) The critical temperature and the upper critical magnetic field are higher than those of a related art metal superconductor.

From these, when magnesium diboride is applied to a superconducting magnet, a system such as, for example, a magnetic resonance imaging (MRI) apparatus or a nuclear magnetic resonance (NMR) apparatus, which is less quenched than the related art and is stable, can be configured. At that time, in order to further improve the stability, it is important to increase the critical current density.

The critical current density of magnesium diboride can be increased by, for example, performing a heat treatment of magnesium diboride together with a carbon-containing material such as silicon carbide (SiC), boron carbide (B₄C) or aromatic hydrocarbon (see non-patent documents 1 and 2). In this case, a boron atom constituting magnesium diboride is replaced by a carbon atom.

Specifically, for example, when silicon carbide or boron carbide is used, these are mixed with magnesium diboride, and a heat treatment at 800° C. or higher is generally performed, so that the replacement is performed. Besides, for example, when aromatic hydrocarbon is used, the replacement can be performed by a heat treatment at about 650° C.

In addition to the techniques as stated above, techniques to increase the critical current density are disclosed in patent document 1 and patent document 2.
[Patent document 1] JP-A-2008-91325
[Patent document 2] JP-A-2008-140556
[Non-patent document 1] S. X. Dou et al. Applied Physical Letters 81 (2002) 3419
[Non-patent document 2] H. Yamada et al. IEEE Trans. Appl. Supercond. No. 17-2 2850-2853, 2007

However, in any of the techniques disclosed in the related art documents, there is a problem that the heat treatment temperature is high. A superconducting wire is generally obtained by performing a heat treatment of raw material. In the techniques of the related art documents, the temperature at the heat treatment is about 650° C. to 800° C. and is high. As a result of the heat treatment at the high temperature, crystal growth is accelerated, and the number of crystal grain boundaries acting as a pinning effect (pinning effect) in an applied magnetic field may be decreased.

As a result, it may be difficult to apply the superconducting wire to, for example, magnetic resonance imaging (MRI) which requires a high critical current density in a middle magnetic field of about 5 T. Besides, it may also be difficult to apply the superconducting wire to nuclear magnetic resonance (NMR) which requires a high critical current density in a high magnetic field exceeding 10 T. That is, if the heat treatment is performed at the high temperature as stated above, there is a possibility that it becomes difficult to obtain the superconducting wire having a high critical current density.

Besides, when silicon carbide is used as a carbon-containing material, magnesium diboride in which carbon replacement is performed can be obtained even by a heat treatment at about 600° C. However, magnesium silicide (Mg₂Si) may be formed as a by-product. As a result, the impurity (magnesium silicide) in the obtained superconducting wire increases, and there is a possibility that the superconducting wire having a high critical current density is not obtained.

### SUMMARY OF THE INVENTION

The invention is made in view of the above circumstances and has an object to provide a superconducting wire which is obtained by a heat treatment at a lower temperature than related art and has a high critical current density, and the process of manufacture.

The inventors made a study diligently in order to solve the problem and as a result, the inventor found that the problem can be solved by causing the mole ratio of boron and carbon contained in carbonized magnesium diboride (part of boron constituting magnesium diboride is replaced by carbon) to magnesium to be a specific ratio, and completed the invention.

According to the invention, a superconducting wire which is obtained by a heat treatment at a lower temperature than related art and has a high critical current density, and the process of manufacture can be provided.

### BRIEF DESCRIPTION OF THE DRAWINGS

FIG. 1 is a view schematically showing a section of a superconducting wire of an embodiment.

FIG. 2 is a view schematically showing a section of a multi-core wire (current lead wire) using the superconducting wire shown in FIG. 1.

FIG. 3 is a view showing respective steps in the process of manufacture of the superconducting wire of the embodiment.

FIG. 4 is a graph showing a relation between an applied magnetic field and a critical current density when the superconducting wire of the embodiment is used.

### DETAILED DESCRIPTION OF THE INVENTION

Hereinafter, although a mode (embodiment) for carrying out the invention will be described, the invention is not limited to the following content, but can be arbitrarily modified and carried out within the scope not departing from the gist of the invention.

### 1. Superconducting Wire

### 1-1. Composition

First, a compound contained in a superconducting wire of an embodiment will be described. The superconducting wire of the embodiment contains a compound (hereinafter, appropriately referred to as “compound of the embodiment” or “compound (1)”) expressed by the following formula (1).

Mg(B₁₋ₓCₓ)_{y} (1)

(where, in the formula (1), x is a number satisfying 0<x<1, and y is a number satisfying 2.1≦y.

That is, the compound (1) is such that part of boron constituting magnesium diboride (MgB₂) is replaced by carbon. In magnesium diboride, 2 moles of boron are combined with 1 mole of magnesium. However, in the compound (1), the total of boron and carbon combined with 1 mole of magnesium is 2.1 moles or more.

For convenience of explanation, the value of y will be first described. In the formula (1), y is a number satisfying 2.1≦y. The specific value of y is arbitrary as long as the value satisfies the range. However, the value of y is preferably 2.4 or more, and more preferably 2.7 or more, and the upper limit of y is preferably 3.2 or less, and more preferably 2.9 or less. When the value of y is set within this range, a heat treatment can be performed at a heat treatment temperature (specifically, the melting point or lower of magnesium) at which crystal growth (that is, enlargement of crystal grain) can be suppressed. The heat treatment as stated above is performed, so that the compound (1) is obtained. On the other hand, when y is excessively large, there is a possibility that unreacted carbon blocks a current path, and it becomes difficult to achieve a high critical current density.

In the formula (1), x is a number satisfying 0<x<1. The specific value of x is arbitrary as long as the value satisfies this range. However, the value of x is preferably 0.15 or less, more preferably 0.12 or less, still more preferably 0.1 or less, and still more preferably 0.05 or less. When the value of x is set in this range, a higher critical current density can be achieved in the obtained superconducting wire.

### 1-2. Physical Properties

The physical properties of the compound of the embodiment are not particularly limited and are arbitrary. For example, the compound of the embodiment is formed by a heat treatment at a temperature of 650° C. or lower (the heat treatment will be described in detail in “2. Process of manufacture of the superconducting wire”). Whether the compound of the embodiment was subjected to the heat treatment at the temperature of 650° C. or lower can be determined by observing the crystal structure of the obtained compound by using a transmission electronic microscope or an X-ray diffraction apparatus.

That is, since the melting point of magnesium is 650° C., if a mixture containing magnesium is subjected to a heat treatment at a temperature exceeding 650° C., magnesium is melted. Thus, the heat treatment becomes a liquid phase reaction, and the crystal structure after cooling becomes quite different from that obtained by the heat treatment at 650° C. or lower. Thus, a high critical current density can not be achieved. Then, it is particularly important that the compound (1) is subjected to the heat treatment at the temperature of 650° C. or lower. Incidentally, whether the heat treatment was performed at 650° C. or lower can be determined by, for example, observing the crystal structure (for example, the size of crystal grain) after cooling by using the above apparatus.

In the compound of the embodiment which is subjected to the heat treatment at 650° C. or lower, the enlargement of crystal grain is prevented, and as a result, a high critical current density is indicated in an applied magnetic field. That is, the heat treatment is performed in a solid phase reaction, so that the crystal growth is suppressed, and the crystal grain size of the compound (1) can be reduced to sub-micron size. Specifically, the crystal grain size obtained when the heat treatment is performed in the temperature range can be made the size of about 10% to 30% of that of the related art case in which the heat treatment is performed at about 800° C. By this, crystal grain boundaries acting as pinning centers increase, and the critical current density in the applied magnetic field is greatly improved.

Incidentally, “the applied magnetic field” to which the superconducting wire (more specifically, the compound (1)) of the embodiment can be applied is not particularly limited. However, the applied magnetic field is normally 3T or more, preferably 5T or more, more preferably 6T or more, still more preferably 7T or more, and still more preferably 8T or more. In the applied magnetic field, the compound of the embodiment has a particularly high critical current density.

Besides, the shape of the compound of the embodiment is normally granular. The average grain size is normally 10 μm or less. The average grain size is within this range, and as a result, the crystal grain boundary is increased as compared with the related art. By this, the pinning effect is enhanced. As a result, the critical current density in the applied magnetic field becomes higher. On the other hand, if the average grain size exceeds 10 the crystal grain boundary is decreased, and the pinning effect is also reduced. As a result, the high critical current density can not be achieved.

### 1-3. Structure

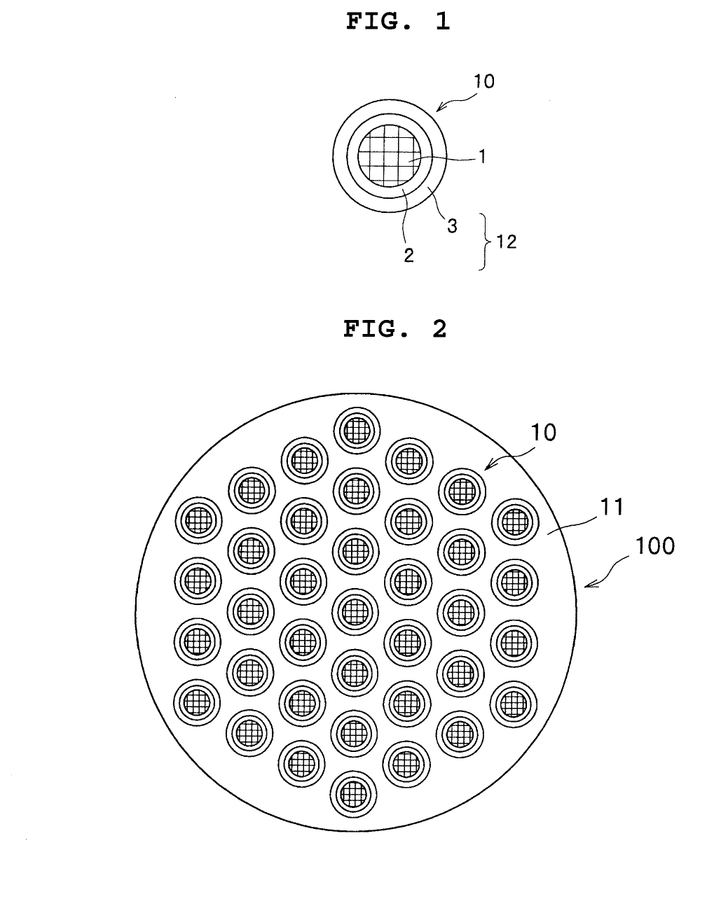

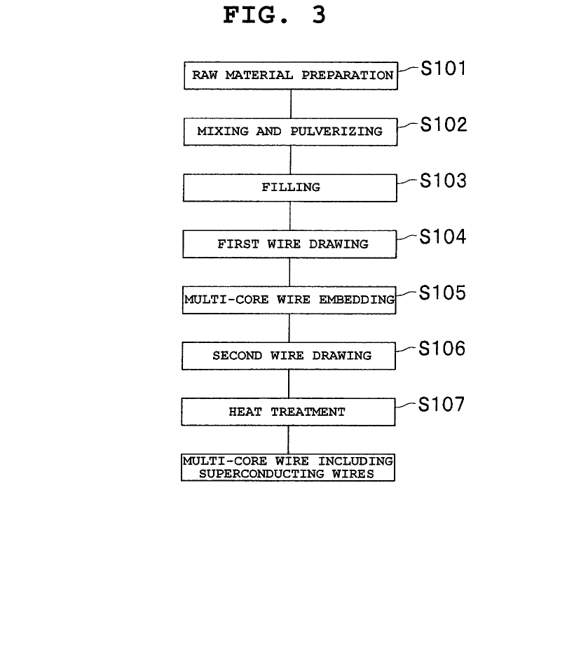

Next, the specific structure of the superconducting wire (superconducting wire of the embodiment) containing the compound of the embodiment will be described with reference to FIG. 1 and FIG. 2. However, the superconducting wire of the embodiment is not limited to the structure shown in FIG. 1 and FIG. 2.

As shown in FIG. 1, the section of the superconducting wire (superconducting wire 10) of the embodiment is circular. The compound (1) denoted by reference numeral 1 is filled in the center, and the outer surface thereof is covered with a covering layer made of metal (in this embodiment, a compound sheath pipe 12 including an iron (Fe) covering layer 2 and a copper (Cu) covering layer 3).

In general, the superconducting wire 10 is used in a multi-core wire including plural such superconducting wires. FIG. 2 shows a section of a multi-core wire 100 in which 37 superconducting wires 10 are sealed with a copper material 11. Incidentally, in FIG. 2, since the copper covering layer 3 of the superconducting wire 10 and the copper material 11 are generally unified, the boundary can not be determined. However, for convenience of illustration, the boundary is shown.

Currents in the same direction flow through all the superconducting wires 10 of the multi-core wire 100, so that a magnetic field is generated around the multi-core wire 100.

### 1-4. Effect

In order to manufacture the superconducting wire having high performance (for example, high critical current density), it is particularly important to pay attention to the following four items.

(1) Selection of a metal sheath pipe which does not metallurgically react with superconductor and has excellent workability.

(2) Improvement of the filling density of superconductor when the wire is made into the final shape.

(3) Improvement of connectivity (current path) between superconductor powders.

(4) Introduction of a pinning center to trap a quantized magnetic flux and to fix the intruding magnetic flux.

The critical current density is not an intrinsic value of a material, and significantly depends on the kind of superconductor constituting the superconducting wire and the process of manufacture of the superconducting wire. Thus, the inventors made a study and found that according to the related art process of manufacture applied to the metal superconducting wire and the oxide superconducting wire, the critical current density of the superconducting wire using magnesium diboride can not be much increased.

Then, the inventors paid attention to the above items and made a diligent study, and consequently, the invention was completed. That is, according to the study of the inventors, when boron constituting magnesium diboride is replaced by carbon, since the structure is distorted at the time of the replacement, a temperature of about 800° C. is generally required at the time of heat treatment. However, the inventors found that if the value of y in the formula (1) is made 2.1 or more, the heat treatment temperature can be lowered to about 600° C. As a result, it was found that crystal growth is suppressed, and high critical current density can be achieved.

According to the invention, a superconducting wire having a high critical current density can be easily manufactured irrespective of the shape. For example, a long superconducting wire having a high critical current density can be easily manufactured. Besides, since the high critical current density is achieved, when the superconducting wire of the embodiment is wound to form a coil or the like, the size of the coil can be made small.

Further, as compared with the related art manufacture of superconducting wire, the superconducting wire can be manufactured by a heat treatment at a low temperature. Thus, a simple heat treatment equipment can be used, and the manufacturing cost can be reduced.

Besides, the superconducting wire of the embodiment can be manufactured by the heat treatment at a temperature of about 600° C. as stated above. Accordingly, for example, aluminum as a stabilizer can also be used. Since the melting point of aluminum is about 650° C., aluminum is not melted by heating at about 600° C. Thus, aluminum can be preferably used as the stabilizer. Since aluminum is a low resistance metal and is light, when the metal as stated above is used, the weight of the superconducting wire can be reduced.

Further, the superconducting wire of the embodiment has superconducting properties as a practical wire. Moreover, an equipment including the superconducting wire of the embodiment can be operated by not only cooling using liquid helium but also cooling using liquid hydrogen, refrigerator conduction cooling or the like. Further, according to the superconducting wire of the embodiment, high superconducting properties can be obtained in a high magnetic field area.

### 2. Process of Manufacture of the Superconducting Wire

The superconducting wire of the embodiment can be manufactured by an arbitrary method, and for example, a powder-in-tube method, an in-situ method, an ex-situ method, a premix method (in-situ/ex-situ) and the like are enumerated. Hereinafter, a specific example will be described with reference to FIG. 3.

Incidentally, the process of manufacture described below is an example, and it is needless to say that the process can be arbitrarily modified and carried out within the scope not departing from the gist of the invention. Besides, in the following description, the process of manufacture of the superconducting wire of the embodiment will be described while the process of manufacture of the multi-core wire shown in FIG. 2 is used as an example.

The process of manufacture of the embodiment mainly includes respective steps shown in FIG. 3.

First, raw material for manufacturing the compound (1) is prepared (raw material preparation step, step S101). The kind and the amount of the raw material are not particularly limited, and the kind and the amount of the raw material are determined so that the composition of the compound (1) is obtained after a heat treatment described later.

However, in the process of manufacture of the embodiment, magnesium diboride and boron carbide are preferably combined and used as the raw material. At this time, the average grain size of boron carbide is preferably 500 nm or less. Incidentally, the grain size can be measured from a photograph taken by a scanning electron microscope.

By using the raw material as stated above, the superconducting wire having a higher critical current density can be manufactured. Specifically, boron carbide is used, so that the mixed carbon-containing material facilitates the diffusion reaction of mixed powders, and as a result, the decomposition of the carbon-containing material can be induced. As a result, since the compound (1) is efficiently produced, the amount of impurities can be reduced. Since the purity of the compound (1) is raised, the superconducting wire having a higher critical current density can be manufactured.

Besides, since boron carbide is used as the carbon source, the metal sheath pipe constituting the superconducting wire is not hydrogen embrittled at the time of the heat treatment. As a result, there is a merit that the wire drawing properties of the superconducting wire are not lowered.

Next, after the raw material is mixed, the material is pulverized (mixing and pulverizing step, step S102). By this operation, mixed powder in which the raw material is uniformly dispersed can be obtained. As an apparatus used for mixing and pulverizing, for example, a planetary ball mill can be used. Besides, the setting condition of the apparatus is not particularly limited, and the apparatus can be arbitrarily set as long as the uniformly dispersed mixed powder can be obtained.

Then, the obtained mixed powder is filled in a hollow compound sheath pipe (corresponding to the compound sheath pipe 12 in FIG. 1) including two layers of an outer copper layer (Cu: corresponding to the copper covering layer 3 in FIG. 1) and an inside iron layer (Fe; corresponding to the iron covering layer 2 in FIG. 1) (filling step, step S103). However, the structure of the compound sheath pipe is not limited to this, and for example, two layers of an outside copper layer and an inside niobium (Nb) layer may be adopted. Further, the number of layers constituting the compound sheath pipe is not limited to two, and only one layer or three or more layers may be suitably adopted.

A layer made of a metal such as niobium, tantalum or titanium is preferably formed on the inner wall of the compound sheath pipe in order to prevent a metallurgical mutual diffusion reaction between iron and mixed powder. However, as stated above, when the inner wall is made of a metal such as niobium, a layer made of iron or the like is preferably provided on the inner surface.

The specific structure (for example, an inner diameter, an outer diameter, a length, etc.) of the compound sheath pipe is not particularly limited, and an arbitrary compound sheath pipe can be used. Further, although the filling method of mixed powder is not particularly limited, the mixed powder is preferably filled in the compound sheath pipe as densely as possible.

Incidentally, as the compound sheath pipe, a sheath pipe made of only one layer is used at the time of filling, and a layer made of a different material may be formed on the outer surface of the sheath pipe at a later step. Specifically, for example, the mixed powder is filled in a sheath pipe made of iron and both ends are sealed (sealing will be described later). Then, the outer surface of the sheath pipe in which both the ends are sealed may be covered with copper. The superconducting wire formed using the pipe formed in this way is the superconducting wire 10 shown in FIG. 1.

The sealing method of both the ends of the compound sheath pipe is not particularly limited, and sealing can be performed by, for example, heating. By this operation, the compound sheath pipe in which the raw material powder is contained is formed. Thereafter, wire drawing is performed until the outer diameter of the compound sheath pipe becomes about 0.5 mm to 2 mm (first wire drawing step, step S104).

As a specific method at the wire drawing, for example, drawbench, hydrostatic extrusion, swage, cassette roller dice, groove roll or the like can be used. The wire drawing is preferably performed at such a strength that cross section reduction ratio per one pass (one time) is 8% to 12%. Gaps in the compound sheath pipe are filled by the first wire drawing step, and the mixed powders can be adhered to each other.

Then, a heat treatment is performed on the compound sheath pipe after the first wire drawing step, so that the superconducting wire of the embodiment is obtained.

A cut object part of the compound sheath pipe subjected to the wire drawing is heated to perform sealing, and then, the compound sheath pipe is cut at the cut object part in the diameter direction. The same operation is repeated, and 37 compound sheath pipes having substantially the same length and sealed both ends are obtained. Thereafter, the obtained 37 compound sheath pipes are inserted in a copper pipe (multi-core embedding step, step S105). The structure of the copper pipe used at this time is arbitrary, and a pipe having such an inner diameter that the 37 compound sheath pipes can be inserted is arbitrarily selected and used. Besides, the sectional shape of the compound sheath pipe when it is inserted in the copper pipe is also arbitrary, and the shape may be, for example, circular or hexagonal.

Then, the copper pipe in which the 37 compound sheath pipes are inserted is subjected to wire drawing in the same way as the first wire drawing step until the outer diameter becomes about 0.5 mm to 1.2 mm (second wire drawing step, step S106). Gaps between the 37 compound sheath pipes and the copper pipe are filled and they are adhered by being subjected to this step. Besides, the gap between the iron covering layer 2 and the copper covering layer 3 (see FIG. 1) constituting the compound sheath pipe can also be filled.

Finally, a heat treatment at a temperature of about 580° C. to 650° C. is performed on the copper pipe subjected to the second wire drawing step (heat treatment step, step S107), so that the multi-core wire (see FIG. 2) including the superconducting wires shown in FIG. 1 can be obtained. By forming the multi-core wire as stated above, the bending properties can be improved, and the density of the superconducting core part can be increased. Incidentally, the time of the heat treatment is not particularly limited, and is generally several minutes to several ten hours.

However, the heat treatment is preferably performed at the lowest possible temperature and for the shortest possible time. By this, the number of crystal grain boundaries effective as pinning centers can be further increased. Particularly, to enhance the pinning effect, that is, to suppress the reduction of the critical current density in an applied magnetic field is especially effective in the application to superconducting magnets which operate in a middle magnetic field (about 5 T) and a high magnetic field (about 10 T).

Besides, although not shown, when the multi-core wire obtained after the heat treatment is further subjected to the wire drawing until the outer diameter becomes about 0.5 mm, the void ratio of the whole multi-core wire can be made approximately 15% or less. A higher critical current density can be obtained by reducing the void ratio as much as possible as stated above.

Although the process of manufacture of the embodiment has been described, as the process of manufacture of the embodiment, a rod-in-tube method may be used in which a pressed powder compact obtained by solidifying and molding a mixed powder is filled (inserted) in a metal sheath pipe and plastic working is performed. Also according to such a method, the superconducting wire and the multi-core wire of the embodiment can be manufactured. Further, the superconducting wire and the multi-core wire may be manufactured by, for example, a flame spraying method, a doctor blade method, a dip-coat method, a spray pyrolysis method, a ferry roll method or the like.

Besides, when necessary, two or more superconducting wires or multi-core wires are combined and are wound into a spiral shape, or are bound into a lead shape or a cable shape and can be used.

### EXAMPLES

Hereinafter, the invention will be described in more detail with reference to examples. However, the invention is not limited to the following examples, and can be arbitrarily modified and carried out within the scope not departing from the gist of the invention.

### Example 1

Magnesium powder (purity: 97% or more) having an average grain size of 45 μm, boron powder (purity: 95% or more) having an average grain size of 5 μm or less, and carbon boride powder (purity: 95% or more) having an average grain size of 500 nm were mixed. At this time, 15 kinds of mixtures were prepared so that x in the formula (1) was 0.02, and y was 1.8 to 3.2. That is, 15 kinds of mixed powders were prepared in which the values of y were different.

Each of the obtained mixed powders was mixed and pulverized in an argon atmosphere for 5 hours by using a planetary ball mill. As a result, mixed powder in which each material is uniformly dispersed was obtained. Incidentally, the ball of the planetary ball mill and a container in which the mixed powder was put were made of zirconium oxide (ZrO₂).

The obtained mixed powder was filled in an iron pipe having an outer diameter of 20 mm, an inner diameter of 16 mm and a length of 500 mm. After filling, wire drawing (first wire drawing step) was repeated so that cross section reduction ratio per one pass was within the range of 8% to 12%, and the wire drawing was performed until the diameter (outer diameter) of the wire became 2.0 mm. Incidentally, even if annealing or the like was not performed during the drawing, all the wires could be drawn without breaking. The drawn wire was cut into 19 wires which have substantially the same length, and those were inserted in a copper pipe having an outer diameter of 17 mm, an inner diameter of 14 mm and a length of 300 mm.

Then, wire drawing (second wire drawing step) was repeated to the copper pipe in which the wires were embedded, so that cross section reduction ratio per one pass was within the range of 8% to 12%, and the wire drawing was performed until the diameter (outer diameter) of the multi-core wire became 1.2 mm. The multi-core wire subjected to the wire drawing was subjected to a heat treatment at 630° C. for 30 hours in an argon atmosphere. By this, the multi-core wire including the superconducting wires was obtained.

The critical temperatures of the obtained multi-core wires were 33K to 37K. Incidentally, as a reference example, the critical temperature of a multi-core wire obtained in the same way except for the use of magnesium diboride was 38.5K.

Table 1 shows the critical current densities of the obtained multi-core wires. Incidentally, the critical current densities shown in Table 1 were measured at 4.2K and under an applied magnetic field of 10 T.

TABLE 1

| y [−] | 1.8 | 1.9 | 2 | 2.1 | 2.2 | 2.3 | 2.4 | 2.5 | 2.6 | 2.7 | 2.8 | 2.9 | 3 | 3.1 | 3.2 |
|---|---|---|---|---|---|---|---|---|---|---|---|---|---|---|---|
| critical current | 30 | 45 | 60 | 100 | 108 | 115 | 122 | 128 | 132 | 140 | 140 | 140 | 120 | 116 | 112 |
| density [A/mm²] | | | | | | | | | | | | | | | |

As shown in Table 1, it is found that as the value of y increases, the critical current density also increases. However, when the value of y is 2.7 to 2.9, the critical current density does not increase any more, and when y increases further, the critical current density decreases.

In Table 1, when the value of y becomes 2.1 or more, the critical current density exceeds 100 A/mm². For example, in the case of y=2.1, the critical current density is about 1.6 times larger than that of the superconducting wire of the related art (y=2). Besides, in the case of y=2.7 to 2.9, the critical current density is about 2.4 times larger than that of the superconducting wire of the related art (y=2).

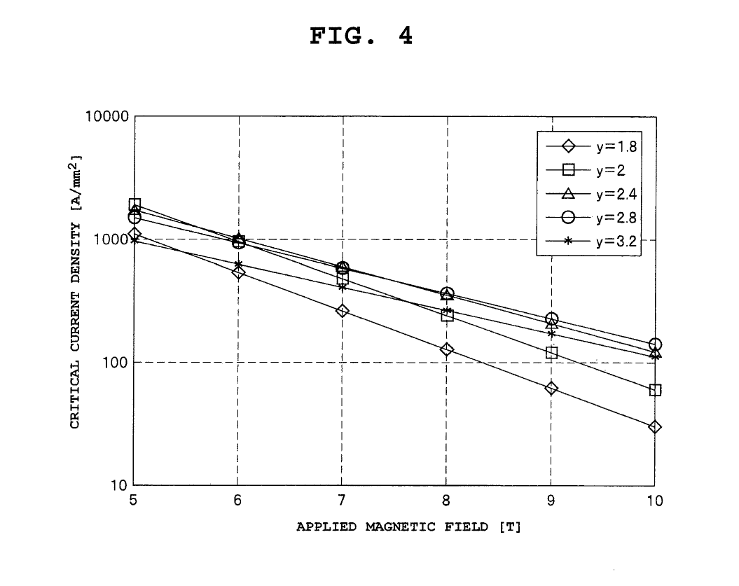

Besides, as shown in FIG. 4, when the applied magnetic field is, for example, 5 T to 10 T, both the superconducting wires of y=2.4 and y=2.8 have the critical current densities higher than that of the superconducting wire of y=2.

As stated above, it is found that at the time when boron constituting magnesium diboride is replaced by carbon, if crystallization is performed so that boron and carbon are excessively combined with magnesium (that is, if y is made 2.1 or more), the high critical current density is obtained especially in the middle magnetic field (about 5T) to the high magnetic field (about 10T). Especially, it is found that if y is made 2.7 to 2.9 which is about 1.4 times larger than y=2 at the stoichiometric composition to magnesium, the critical current density becomes especially large.

### Example 2

Superconducting wires were manufactured similarly to the example 1 except for y=2 (fixed) and x=0.01 to 0.3. That is, 11 mixed powders different in the value of x were used, and the superconducting wires and the multi-core wires were manufactured.

The critical current densities of the obtained multi-core wires were measured similarly to the example 1. Table 2 shows the result.

TABLE 2

| x [−] | 0.01 | 0.02 | 0.03 | 0.05 | 0.1 | 0.12 | 0.15 | 0.18 | 0.2 | 0.25 | 0.3 |
|---|---|---|---|---|---|---|---|---|---|---|---|
| critical current | 58 | 60 | 58 | 58 | 56 | 53 | 50 | 25 | 10 | 7 | 3 |
| density [A/mm²] | | | | | | | | | | | |

As shown in Table 2, it is found that when x becomes larger than 0.15, the critical current density abruptly decreases. From the observation of crystal structure by a scanning electron microscope photograph, it is found that this is caused because unreacted boron and carbon, which do not react even when the heat treatment is performed and remain, block a current path.

Incidentally, although Table 2 shows the result in the case of y=2, almost the same result was obtained also in the case of y=1.8 to 2.8. Accordingly, it is found that the value of x is preferably 0.15 or less.

### Example 3

Superconducting wires and multi-core wires were manufactured similarly to the example 1 except that y was made 2.8 at which the highest critical current density was obtained in the example 1, x was made 0.02 at which the highest critical current density was obtained in the example 2, the heat treatment temperature was changed in the range of from 600° C. to 800° C., and the heat treatment time was made 20 hours. The critical current density was measured for the obtained multi-core wires similarly to the example 1. Table 3 shows the result.

TABLE 3

| tempera- | | | | | | | | | |
|---|---|---|---|---|---|---|---|---|---|
| ture [° C.] | 600 | 620 | 630 | 650 | 670 | 700 | 750 | 800 | 850 |
| critical | 130 | 138 | 140 | 135 | 107 | 105 | 95 | 82 | 65 |
| current | | | | | | | | | |
| density | | | | | | | | | |
| [A/mm²] | | | | | | | | | |

As shown in Table 3, it is found that the critical current density significantly varies according to the heat treatment temperature. Especially, when the heat treatment temperature is 650° C. or lower, the critical current densities exceed 100 A/mm² and are almost equal to each other. However, when the heat treatment temperature exceeds 650° C., the critical current density gradually decreases. Especially, when the temperature is 800° C. which is equal to that of the related art, the critical current density is lower than, for example, the critical current density at 630° C. by about 40%. From these, it is found that the heat treatment temperature is preferably 650° C. or lower.

### Example 4

The sections of the multi-core wires (specifically, the superconducting wires) manufactured in the example 1 and the example 2 were observed, in respect to the crystal structure (microstructure) using a scanning electron microscope. As a result, in the superconducting wires whose critical current densities exceeded 100 A/mm², the average grain size of the compound (1) was 10 μm or less. From this, it is found that when the average grain size of the compound (1) is 10 μm or less, a higher critical current density is obtained.

### Example 5

Superconducting wires and multi-core wires were manufactured similarly to the example 1 except that y was made 2.8, and the average grain size of boron carbide was made 50 nm to 1000 nm. The critical current densities of the obtained multi-core wires were measured similarly to the example 1. Table 4 shows the result.

TABLE 4

| average grain size [nm] | 50 | 100 | 200 | 500 | 700 | 1000 |
|---|---|---|---|---|---|---|
| critical current | 150 | 145 | 145 | 140 | 90 | 70 |
| density [A/mm²] | | | | | | |

As shown in Table 4, when the average grain size of boron carbide is 500 nm or less, the critical current densities are almost equal to each other. However, when the average grain size exceeds 500 nm, the critical current density gradually decreases. Especially, when the average grain size becomes 1 μm which is twice as large as 500 nm, the critical current density is halved. From these, it is found that the average grain size of boron carbide is preferably 500 nm or less.

What is claimed is:

1. A superconducting wire comprising a compound expressed by a following formula (1):
Mg(B₁₋ₓCₓ)_{y} (1)
where, x is a number satisfying 0<x<1, and y is a number satisfying 2.1≦y.

2. The superconducting wire according to claim 1, wherein x is a number satisfying x≦0.15.

3. The superconducting wire according to claim 1, wherein the compound is subjected to a heat treatment at a temperature of 650° C. or lower.

4. The superconducting wire according to claim 2, wherein the compound is subjected to a heat treatment at a temperature of 650° C. or lower.

5. The superconducting wire according to claim 1, wherein an average grain size of the compound is 10 μm or less.

6. The superconducting wire according to claim 2, wherein an average grain size of the compound is 10 μm or less.

7. The superconducting wire according to claim 3, wherein an average grain size of the compound is 10 μm or less.

8. A process of manufacture of the superconducting wire according to claim 1, comprising:
mixing magnesium diboride and boron carbide, wherein
an average grain size of the boron carbide is 500 nm or less.
